(19) United States
(12) Patent Application Publication
(10) Pub. No.: US 2010/0186232 A1
(43) Pub. Date: Jul. 29, 2010

(54) PRODUCTION METHOD OF PISTON FOR COMPRESSOR

(76) Inventors: Yoshitaka Ootsuki, Isesaki-shi (JP); Yuusuke Kurokawa, Isesaki-shi (JP); Yukio Sako, Kumagaya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 12/602,023

(22) PCT Filed: May 20, 2008
(86) PCT No.: PCT/JP2008/059200

§ 371 Date: Apr. 5, 2010

(30) Foreign Application Priority Data
May 29, 2007 (JP) 2007-141604

(51) Int. Cl. B23P 15/10

(52) U.S. Cl. 29/888.04

(57) ABSTRACT

A method for producing a hollow piston for compressor by coupling a piston top side member and a rotation preventing portion side member where a rotation preventing portion and a cylindrical portion are formed integrally. When the rotation preventing portion side member is formed, an intermediate material for forging the rotation preventing portion side member is formed, the cylindrical portion of the rotation preventing portion side member is forged in a uniaxial direction by molding for pushing the cylindrical portion rearward in a punch inserting direction using a punch having a tip portion formed asymmetrically to a piston axis, and a material theft portion is formed to copy the asymmetric profile at the tip of the punch on the rotation preventing portion side bottom of the hollow section for forming the cylindrical portion. A hollow piston can be produced by simple and inexpensive forging and the position of the center of gravity can be brought closer to the axis of the cylindrical portion of the piston.

### TECHNICAL FIELD OF THE INVENTION

The present invention relates to a method for producing a piston for a compressor, and specifically, to a method for producing a hollow piston which is formed by coupling two members.

### BACKGROUND ART OF THE INVENTION

For a piston in a reciprocating-piston-type compressor, a driving force transmitted from a driving force input member, such as a swash plate, is transformed via a shoe, etc., into a reciprocation of the piston. When such a piston is formed in a hollow shape for weight saving, etc., for example, a piston whose main body is hollow-shaped can be produced by forming two members each shaped like a bottomed container, wherein one of the two members is formed integrally with a rotation preventing portion which engages a side of driving force input member and prevents the piston from rotating, and the one is coupled with the other piston top side member forming a piston top side. Because of being reciprocated at a high speed, the hollow piston is preferably as lightweight as possible, and therefore, the hollow section is desired to be formed as largely as possible, and to achieve this, for example, a structure where a material theft portion is provided on a rotation preventing portion side bottom of the hollow section is known (for example, Patent document 1).

However, in the structure disclosed in Patent document 1, as depicted in FIG. 6, because material theft portion 103 in hollow section 102 of rotation preventing portion side member 101 before machining the rotation preventing member is formed only in a part of center axis 105 of cylindrical portion 104 forming hollow section 102 (center axis of the piston), the size of material theft portion 103 is limited and the weight saving of the piston also has a limitation.

On the other hand, a structure where a comparatively large material theft portion is provided on a rotation preventing portion side bottom of a hollow section is disclosed in Patent document 2. In such a production method of a piston disclosed in Patent document 2, focusing attention on such an advantage of forging production that lightweight structure can be realized more easily and the strength and quality of exterior appearance can be improved more easily than casting, the forging is employed as a production method of the rotation preventing portion side member of the hollow piston.

In the production method of a piston in Patent document 2, however, the rotation preventing portion side member is forged in biaxial directions using a side punch, from the reason why the forging cannot be performed in a uniaxial direction. However, because this production method is basically a forging for flashing squeeze, improvement of the yield of materials cannot be expected so much. Further, it is extremely difficult to form the cylindrical portion using the punch at a condition having the flash, and such a production method is not realistic. Furthermore, the forging equipment of biaxial directions is expensive and is extremely disadvantageous in production cost.

In addition, generally in a follow piston, the closer to a center axis of the cylindrical shape a center of gravity of the hollow piston is, the better the dynamic balance becomes, so as to be able to suppress vibrations and noises. Therefore, in the above-described forming of the material theft portion in the hollow section, how the effect of weight saving can be improved and how close the center of gravity can be approached to the center axis of the hollow section become important on design.
Patent document 1: JP-A-11-294320
Patent document 2: JP-B-3777942

### DISCLOSURE OF THE INVENTION

### Problems to be Solved by the Invention

Accordingly, taking into account the above-described matter to be considered on design as well as focusing on the above-described problems in prior arts, an object of the present invention is to provide a production method of a piston for a compressor, where a material theft portion can be formed largely and where its shape can be easily optimized, so that a hollow section-shaped piston which can achieve a weight saving most efficiently can be produced by simple and inexpensive forging and a position of the center of gravity can be approached more closely to a center axis of a cylindrical portion.

### Means for Solving the Problems

To solve the above-described problem, a production method of a piston for a compressor according to the present invention is a method for producing a hollow piston for a compressor by coupling (a) a rotation preventing portion side member where a rotation preventing portion and a cylindrical portion are formed integrally, the rotation preventing portion preventing the piston from rotating at a side of driving force input for reciprocation, and (b) a piston top side member forming a piston top side, characterized in that, when the rotation preventing portion side member is formed, an intermediate material for forging the rotation preventing portion side member is formed, the cylindrical portion of the rotation preventing portion side member is forged in a uniaxial direction by a rearward push-molding for pushing the cylindrical portion rearward in a punch inserting direction using a punch having a tip portion formed asymmetrically to a piston axis, and a material theft portion is formed in a shape along an asymmetric profile at the tip portion of the punch on a rotation preventing portion side bottom of a hollow section for forming the cylindrical portion.

In the method for producing a piston for a compressor according to the present invention, being molded by forging the cylindrical portion of the rotation preventing portion side member in a rearward extrusion, the rotation preventing portion side member can be molded by forging in a uniaxial direction and therefore forged parts which can easily realize a lightweight structure and which can easily improve the strength or the exterior quality can be formed with inexpensive forging equipment, despite that it has been supposed unable to be molded by forging in a uniaxial direction according to Patent document 2. In this forging, the punch having its tip portion formed in an asymmetrical profile to the piston axis is used to forge into a shape along the asymmetrical profile part, so as to make it possible to form a material theft portion having an optimum size and shape for weight saving on the rotation preventing portion side bottom of the hollow section which forms the cylindrical portion (in other words, in a part targeted for the forging by the asymmetrical profile part of the tip portion of the punch), and therefore, the hollow section can be formed in the most effective shape for weight saving.

In such a method for producing a piston for a compressor, it is preferable that the asymmetric profile of the tip portion of the punch is formed in a shape in which a volume of the tip portion of the punch is one-sided in a section corresponding to a periphery side of the compressor. In other words, the rotation preventing portion is generally positioned at a periphery of the compressor, being biased from the center of the piston axis, so that the center of gravity as the whole piston tends to be biased at the periphery of the compressor. For correcting the bias of the location of the center of gravity as much as possible, it is effective to thieve large amount of material from the peripheral side part of the compressor, concerning the rotation preventing side member. To achieve this, it is preferable that the asymmetric profile of the tip portion of the punch forming the material theft portion is formed in a shape in which a volume is one-sided in a section corresponding to a periphery side of the compressor.

However, when the above-described asymmetrical profile of the tip portion of the punch is employed, in inserting the punch at the time of forging the punch tends to be pulled to the profile side having biased volume, so that it may be displaced from the targeted insertion position. In order to suppress this, it is preferable that, when the cylindrical portion is molded by forging, the punch is inserted at a condition being offset toward a side opposite to the material theft portion relative to a center axis of the cylindrical portion.

Further, for preventing the punch from being displaced toward the side of the profile part having biased volume, it is effective to form an inclination preventing shape portion of the punch inserted on at least a part of the rotation preventing portion side bottom of the hollow section for forming the cylindrical portion. For example, the inclination preventing shape portion is formed in a shape portion with a taper surface. The tapering direction of the taper surface is enough to be set so that the position of the tip portion of the punch is corrected into the direction corresponding with the axial center of the cylindrical portion in which the axial center of the punch is supposed to be formed.

In addition, in the method for producing a piston for a compressor according to the present invention, an engagement portion which engages a driving force input member in the rotation preventing portion can be formed basically by machining.

### Effect According to the Invention

In the method for producing a piston for a compressor according to the present invention, the cylindrical portion of the rotation preventing portion side member is formed in forging by a rearward extrusion, so that a desirable lightweight structure can be easily formed by a uniaxial inexpensive forging equipment. Further, when the tip portion is forged using an asymmetrical punch, so that a desirable material theft portion having the optimum size and shape for weight saving can be formed on the bottom of the hollow section of the rotation preventing portion side member, and therefore, weight saving for the piston can be achieved effectively. Furthermore, when the tip portion or the material theft portion is optimized in shape, the position of the piston center of gravity can be approached closer to the center axis of the cylindrical portion.

### BRIEF EXPLANATION OF THE DRAWINGS

FIG. 1 is a cross sectional view showing the completion form of a piston produced by the production method of the piston according to an embodiment of the present invention.

FIG. 2 is a cross sectional view of the intermediate material to forge the rotation preventing portion side member of the piston depicted in FIG. 1.

FIG. 3 is a cross sectional view showing a state of forging of the rotation preventing portion side member of the piston depicted in FIG. 1.

FIG. 4 is a bottom plan view of the cylindrical portion of the rotation preventing portion side member depicted in FIG. 3.

FIG. 5 is a cross sectional view showing a state of forging of the rotation preventing portion side member in the production method of a piston for a compressor according to another embodiment of the present invention.

FIG. 6 is a cross sectional view showing a state of forging of the rotation preventing portion side member in a conventional production method of a piston.

### EXPLANATION OF SYMBOLS

1: piston
2: rotation preventing portion
3: cylindrical portion
4: rotation preventing portion side member
5: piston top side member
6: hollow section
7: shoe
8: swash plate
9: intermediate material
10: tip portion of punch
11: piston axis
12: punch
14: material theft portion
15: taper surface
16: inclination preventing shape portion
21: rotation preventing portion side member
22: material theft portion
23: cylindrical portion
24: taper surface
25: inclination preventing shape portion

### THE BEST MODE FOR CARRYING OUT THE INVENTION

Hereinafter, a desirable embodiment of the present invention will be explained referring to figures.

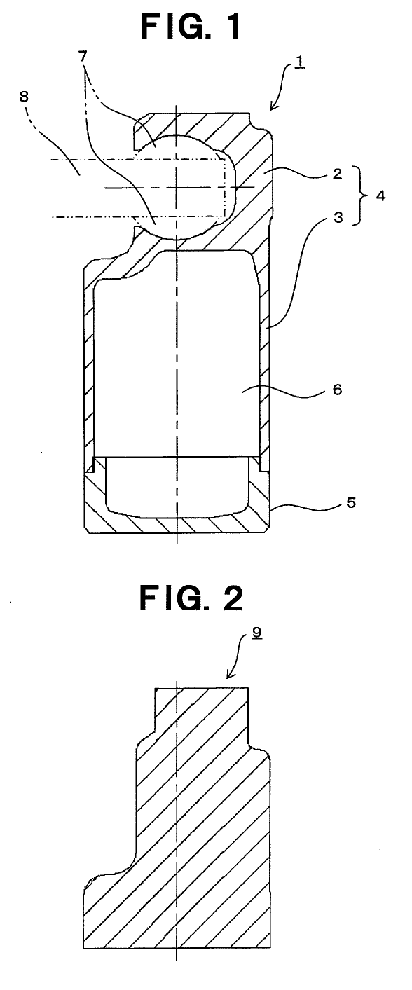

At first, FIG. 1 shows the completion form of a piston produced by the production method of the piston according to an embodiment of the present invention. Piston 1 depicted in FIG. 1 is produced as a piston for a compressor having hollow section 6, by coupling (a) rotation preventing portion side member 4 where rotation preventing portion 2 and cylindrical portion 3 are formed integrally, rotation preventing portion 2 preventing piston 1 from rotating at a side of driving force input for reciprocation, and (b) piston top side member 5 forming a piston top side. In rotation preventing portion 2, for example, a pair of shoe 7 are held and swash plate 8 which rotates synchronized with a drive shaft of the compressor is contacted sliding with shoe 7, so that the rotation of swash plate 8 is transformed into the reciprocation of piston 1.

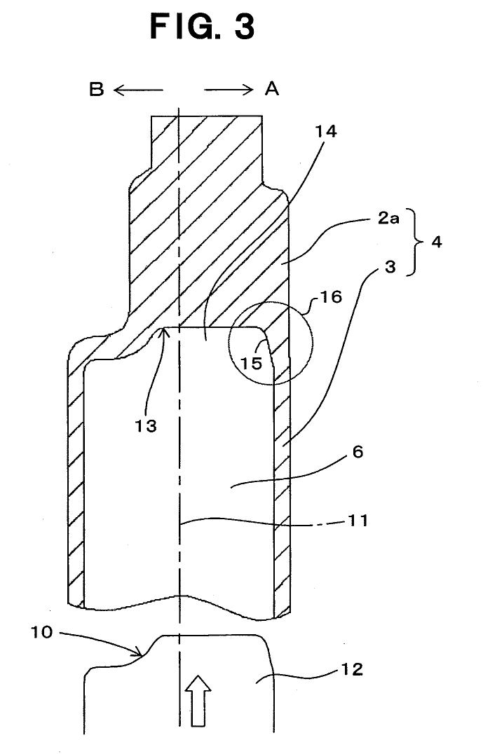

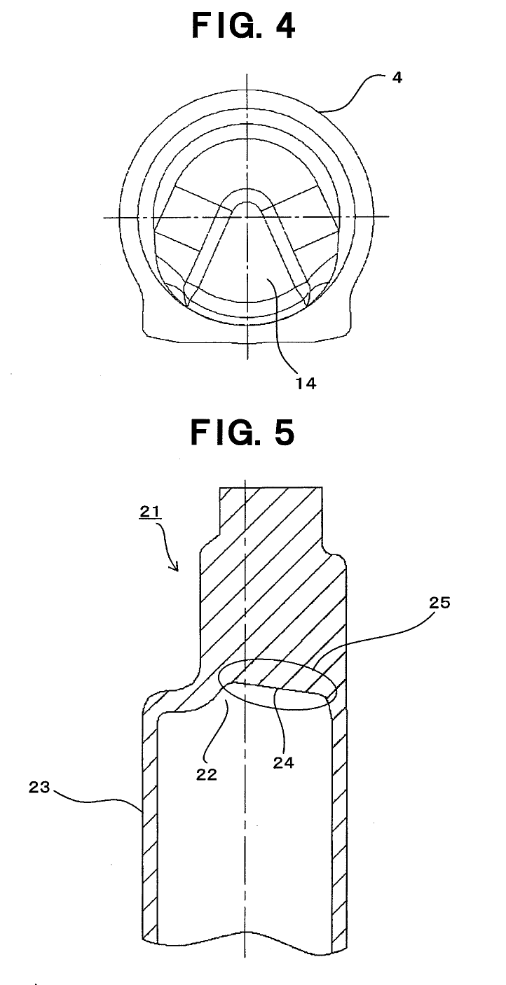

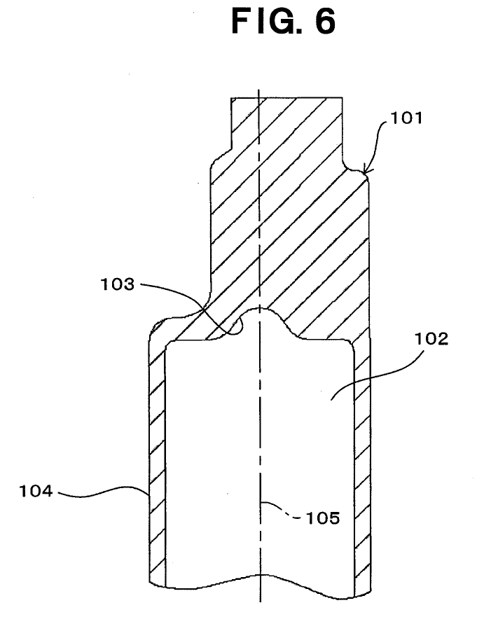

Rotation preventing portion side member 4 is produced as follows. At first, intermediate material 9 to forge rotation preventing portion side member 4 is formed and prepared into a shape depicted in FIG. 2. Using punch 12 whose tip portion 10 is formed into an asymmetrical profile to piston axis 11 as depicted in FIG. 3, Intermediate material 9 is formed in forging by rearward extrusion pushing cylindrical portion 3 rearward in a punch insertion direction (arrow direction) in a uniaxial direction. For this forging step rotation preventing portion 2 is being shown as rotation preventing portion 2a remaining a shape before machining, though being finally formed by machining into a shape shown in FIG. 1. By such a forging, material theft portion 14 is formed in a shape along an asymmetric profile at tip portion of punch 10 on rotation preventing portion side bottom 13 of hollow section 6 for forming cylindrical portion 3. FIG. 4 shows a cylindrical bottom side of rotation preventing portion side member 4 where material theft portion 14 is formed.

In this embodiment, the asymmetrical profile of tip portion of punch 10 is formed in a shape in which a volume of tip portion of punch 10 is one-sided in a section corresponding to a periphery side (side-A in FIG. 3) of the compressor. Material theft portion 14 is supposed to be formed in a shape along the biased shape of the volume in tip portion of punch 10. Thus, by biasing the volume in tip portion of punch 10 and forming material theft portion 14 which is relatively large in the section corresponding with the periphery of the compressor, the eccentric tendency of the center position of gravity of whole piston 1 based on a shape of rotation preventing portion 2 as depicted in FIG. 1 can be corrected. In other words, the center of gravity of piston 1 can be corrected so as to approach closer to the position of center axis in cylindrical portion 3.

Further, when punch 12 is inserted at the time of forging, punch 12 is inserted at a condition being offset toward a side opposite to material theft portion 14 relative to a center axis of cylindrical portion 13 in this embodiment. As described above, at the time of forging when punch 12 with the biased volume is inserted in tip portion 10, punch 12 tends to be pulled toward the biased profile side (side-A in FIG. 3), so that it may be displaced from the targeted insertion position. In order to suppress that, the insection is performed at the offset condition.

Furthermore, in this embodiment, tip portion of punch 12 and side-A part in FIG. 3 on the rotation preventing portion side bottom of hollow section 6 forming cylindrical portion 3 are formed into inclination preventing shape portion 16, in order to make the axial center of punch 12 precisely concentric with the axial center of cylindrical portion 3 at the time of insertion of punch 12, and specifically to suppress punch 12 to be pulled toward the biased profile side (side-A in FIG. 3) in which a volume of tip portion of punch 10 is one-sided. Inclination preventing shape portion 16 is provided like this, so that the corresponding part of tip portion of punch 12 is forced from taper surface 15 on the rotation preventing portion side bottom by a correction force which makes the axial center of punch 12 approach closer to the axial center of cylindrical portion 3, for every punching in forging.

Rotation preventing portion side member 4 which is formed as described above is coupled with piston top side member 5, as shown in FIG. 1. The coupling is performed by press-fitting, or with additional welding, etc. Before the coupling or after the coupling, rotation preventing portion 2 is formed into a shape depicted in FIG. 1 by machining.

FIG. 5 shows rotation preventing portion side member 21 (before machining of the rotation preventing portion) produced by the production method of a piston for a compressor according to another embodiment of the present invention. In this embodiment, in comparison with the above-mentioned embodiment, the shape of material theft portion 22 has been altered as shown in FIG. 5. Taper surface 24 is provided in almost all material theft portion 22 formed on the bottom of cylindrical portion 23, so that the profile part having taper surface 24 functions as inclination preventing shape portion 25 of the position of the axial center of the punch at the time of inserting the punch (not shown), in the same way as described above. Other composition and function are pursuant to the above described embodiments.

### INDUSTRIAL APPLICATIONS OF THE INVENTION

The method for producing a piston for a compressor according to the present invention is applied to produce any hollow piston having the rotation preventing portion.

1. A method for producing a hollow piston for a compressor by coupling (a) a rotation preventing portion side member where a rotation preventing portion and a cylindrical portion are formed integrally, said rotation preventing portion preventing said piston from rotating at a side of driving force input for reciprocation, and (b) a piston top side member forming a piston top side, characterized in that, when said rotation preventing portion side member is formed, an intermediate material for forging said rotation preventing portion side member is formed, said cylindrical portion of said rotation preventing portion side member is forged in a uniaxial direction by a rearward push-molding for pushing said cylindrical portion rearward in a punch inserting direction using a punch having a tip portion formed asymmetrically to a piston axis, and a material theft portion is formed in a shape along an asymmetric profile at said tip portion of said punch on a rotation preventing portion side bottom of a hollow section for forming said cylindrical portion.

2. The method for producing a piston for a compressor according to claim 1, wherein said asymmetric profile of said tip portion of said punch is formed in a shape in which a volume of said tip portion of said punch is one-sided in a section corresponding to a periphery side of said compressor.

3. The method for producing a piston for a compressor according to claim 1, wherein, said cylindrical portion is molded by forging, said punch is inserted at a condition being offset toward a side opposite to said material theft portion relative to a center of an axis of said cylindrical portion.

4. The method for producing a piston for a compressor according to claim 1, wherein an inclination preventing shape portion of said punch inserted is formed on at least a part of said rotation preventing portion side bottom of said hollow section for forming said cylindrical portion.

5. The method for producing a piston for a compressor according to claim 4, wherein said inclination preventing shape portion is formed in a shape portion with a taper surface.

6. The method for producing a piston for a compressor according to claim 1, wherein an engagement portion which engages a driving force input member in said rotation preventing portion is formed by machining.
